(19) United States
(12) Patent Application Publication
(10) Pub. No.: US 2011/0305999 A1
(43) Pub. Date: Dec. 15, 2011

(54) MODIFIER OF COMBUSTION OF SOLID, LIQUID AND GASEOUS FUELS

(76) Inventor: Marek Majcher, Warka (PL)

(21) Appl. No.: 13/203,556

(22) PCT Filed: Apr. 1, 2009
(86) PCT No.: PCT/PL2009/000028

§ 371 Date: Aug. 26, 2011

(30) Foreign Application Priority Data
Mar. 7, 2009 (PL) P-387423

(51) Int. Cl. F23J 7/00; B01J 31/12

(52) U.S. Cl. 431/4; 502/155

(57) ABSTRACT

The present disclosure relates to the modifier of combustion of solid, liquid and gaseous fuels, in particular wood, natural gas, coal, mazout and other hydrocarbons, in power boilers, in closed or open chambers, wherein it contains from 10 to 30 wt. % of water, from 20 to 80 wt. % of at least one aliphatic alcohol, from 5 to 15 wt. % of carbamide or its derivatives, and from 5 to 15 wt. % of monoacetylferrocene. Object of the disclosure is also a method of modifying process of combustion of the above-mentioned fuels and a use of the modifier of fuel combustion.

Object of the invention is a modifier of combustion of solid, liquid and gaseous fuels, in particular wood, natural gas, coal, mazout and other hydrocarbons, a method of modifying a process of combustion of fuels and a use of the modifier of fuel combustion.

Processes of combustion of solid, liquid and gaseous fuels are still being improved. In particular, all methods that allow to increase a process yield and limitation of emission of harmful substances to atmosphere are investigated. Additives of various types that modify processes taking place during combustion of fuels in power boilers are often used. In particular, preventing from carbon black and other sludge banks settling in boilers that are fired with hard coal, brown coal, coke or fine coal, is desirable.

In Polish patent PL165406, a catalyst for after-burning of carbon black that includes sodium chloride, ammonium chloride, hydrated cupric sulphate and calcium hydroxide is disclosed. The catalyst is a mixture of inorganic compounds in solid state and is used as an additive to solid fuels.

Ferrocene derivatives belong to a group of metal organic compounds from a group of cyclopentadienyl complexes. Complexes with iron II constitute a sandwich system, in which two ligands are bound with a metal cation located between them. Derivatives of such type are known and are used as catalysts of chemical processes.

From Japanese patent specification JP2000247990, the use of cyclopentadiene complexes in chemical synthesis, e.g. during preparation of aromatic amines, is known.

From Swiss patent CH 599464, the use of ferrocene as a catalyst of processes of combustion to be used as an additive to fuels used in engines, e.g. motor car engines, is known.

The aim of the present invention is to develop a universal modifier of combustion of all types of fuels in power boilers, which acts as a catalyst that limits settling carbon black and coal tar type substances, ensures its after burning and reduces emission of undesirable substances, e.g. carbon monoxide, to atmosphere and—at the same time—considerably enhances a yield of processes of combustion by reducing consumption of the respective fuels.

Object of the invention is a modifier of combustion of solid, liquid and gaseous fuels, in particular wood, natural gas, coal, mazout and other hydrocarbons, in power boilers, in closed or open chambers, characterised in that it contains from 10 to 30 wt. % of water, from 20 to 80 wt. % of at least one aliphatic alcohol, from 5 to 15 wt. % of carbamide or its derivatives and from 5 to 15 wt. % of monoacetylferrocene.

Preferably, the modifier contains from 10 to 30 wt. % of water, from 20 to 40 wt. % of isopropanol, from 20 to 40 wt. % of n-butanol, from 5 to 15 wt. % of carbamide and from 5 to 15 wt. % of monoacetylferrocene, more preferably it contains from 15 to 25 wt. % of water, from 25 to 35 wt. % of isopropanol, from 25 to 35 wt. % of n-butanol, from 8 to 12 wt. % of carbamide and from 8 to 12 wt. % of monoacetylferrocene.

Preferably, the modifier contains 20 wt. % of water, 30 wt. % of isopropanol, 30 wt. % of n-butanol, 10 wt. % of carbamide and 10 wt. % of monoacetylferrocene.

Object of the invention is also a method of modifying a process of combustion of solid, liquid and gaseous fuels, in particular wood, natural gas, coal, mazout and other hydrocarbons, in power boilers, in closed or open chambers, characterised in that the modifier of combustion containing from 10 to 30 wt. % of water, from 20 to 80 wt. % of at least one aliphatic alcohol, from 5 to 15 wt. % of carbamide or its derivatives and from 5 to 15 wt. % of monoacetylferrocene is diluted additionally with water at a ratio of 2.5 to 40 ml of the modifier per 1 litre of water and the resulting diluted composition is metered to an aeration system of a combustion chamber, preferably through pumping together with air to the aeration system.

Preferably, the modifier containing from 10 to 30 wt. %, more preferably 20 wt. % of water, from 20 to 40 wt. %, more preferably 30 wt. % of isopropanol, from 20 to 40 wt. %, more preferably 30 wt. % of n-butanol, from 5 to 15 wt. %, more preferably 10 wt. % of carbamide and from 5 to 15 wt. %, more preferably 10 wt. % of monoacetylferrocene is used in the method.

In case of aeration of the combustion chamber with cold air, the modifier is metered by means of spraying and in case of aeration of the combustion chamber with hot air, a boiler proper is used.

From 10 to 50 ml of the modifier per 1000 kg of coal or from 5 to 47 ml of the modifier per 1000 cubic metres of natural gas Gz-50 or from 10 to 100 ml of the modifier per 1000 litres of liquid fuels, such as mazout and furnace oil is metered in the method. The given amounts of the modifier were recalculated as based on its composition prior to the additional dilution with water.

Object of the invention is also a use of the modifier of combustion defined above for increasing a yield of combustion of solid, liquid and gaseous fuels and a use as a catalyst in power boilers, and also for after-burning of carbon black, furnace gases and other impurities present in the combustion chamber, for example dusts and coal tar-type substances, and for purifying of combustion chamber and canals in power boilers from sludge banks.

Object of the invention is also a use of the modifier of combustion containing water, aliphatic alcohols, carbamide or its derivatives, and monoacetylferrocene, for increasing a yield of combustion of solid, liquid and gaseous fuels, and a use as a catalyst in power boilers, and also for after-burning of carbon black, furnace gases and other impurities present in the combustion chamber, for example dusts and coal tar-type substances and for purifying of combustion chamber and canals in power boilers from sludge banks.

One of prospective directions when utilising the modifier of combustion of the invention is a use for modifying the process of fuel combustion in boilers of heat and power engineering companies. The study we have performed has demonstrated that reduction in relative consumption during modified fuel combustion constitutes for natural gas GZ-50 not less than 4-6%, for diesel oil 8-12%, and for mazout and coal 10-15%.

Experiments concerning practical implementation of the modifier of the invention ie. inter alia a composition of the modifier referred to as Reduxco (a trade mark submitted to Patent Office of Republic of Poland, Application No. Z-350906) have evidenced that a possibility of fuel saving per unit of a manufactured product amounts even up to 25%. An extra effectiveness of processes was achieved through introducing a slight modification of aeration system of combustion chamber, not involving construction changes in a power boiler. A use of the modifier of the invention results in good condition of boilers without necessity of introducing changes in boiler-room equipment.

It is also crucial that the modifier acts in all boiler sections ie. in the boiler furnace area, combustion chamber area and all canals, chimney piping, which causes that within the whole mentioned area advantageous changes occur, and after-burning of furnace gases, dusts and sludge banks—also outside of a boiler furnace—takes place.

The modifier of the invention can be successfully used in power boilers of any type e.g. of OR, OP, OB, WP, WR, EK, BB-type, while using various fuels, such as hard coal, brown coal, briquettes of various types, biofuels and their compositions in a mixture with coal strippings, fuels based on wood and all wood waste materials, possibly processed or not, low-grade fuels of such type based on peat, sawdust, bark or straw. The invention is also applicable for gaseous and liquid fuels such as mazout or oil, and also for various mixtures and contaminated fuels.

An application of the modifier according to present invention makes it possible to use very wet materials, such as wood, straw and other cellulose fuels of high humidity, as a fuel. The modifier makes it also possible to perform waste management through combustion of such waste materials as plastics, waste materials from meat and bones, and chemical substances, without a danger for environment. For the proper course of the process, the moisture content should be about 50%. The only products of combustion are carbon dioxide and water steam.

In the first step, carbon monoxide is produced from organic mass. In the second step, it is burned to produce carbon dioxide. In this step, decomposition of water (water steam) into hydrogen and oxygen occurs. Under normal conditions that step requires temperature of about 1600° C. When using the modifier of the invention, the process temperature may be reduced to 450-850° C. In the third step, hydrogen combustion takes place accompanied by large amounts of heat.

The essential component of the modifier of the invention is a complex being an iron carrier—monoacetylferrocene: cyclopenta-1,3-diene; 1-(1-cyclopenta-2,4-dienylidene) etanolate of ferrum ion 2+. In transformations that occur during processes of combustion, presence of hydroxyl groups in a reaction medium is of crucial importance. The modifier contains also carbamide or its derivatives, such as alkylurea of R₁R₂N(CO)NR₁R₂ type, where R₁, R₂, R₃, R₄ are the same or different and constitute C₁-C₆ alkyl groups, e.g. methylene or ethylene groups.

Aliphatic alcohols used in the modifier of the invention can have linear or branched chains. The modifier should include at least one alcohol (carrier of OH groups). Preferably alcohol is selected from a group of C₃-C₁₁ alcohols, more preferably C₃-C₈ alcohols, in particular C₃-C₆ alcohols. Examples of alcohols used are: ethanol, propanol, isopropanol, n-butanol, pentanol, heptanol and octanol. Through alcohol selection, a ratio of hydroxyl groups to a number of carbon atoms in a chain is changed, and thereby so is the ratio of hydroxyl groups to a mass of other components of the modifier. Advantageous effects are obtained when using alcohols of moderate chain length e.g. isopropanol and n-butanol. Thus, a mixture of the two alcohols in the modifier is preferably used. On the other hand, the modifier can contain only one alcohol of the mentioned group or a mixture of three or four alcohols.

A mixture of the modifier may also include additives, which do not influence its properties. e.g. dyes, to make a distinction between various types of the modifier.

One can assume that during combustion processes, complex ligands based on an N-radical having a complexing centre constituted by an iron ion with built-in hydroxyl groups and hydrocarbon chains in a suitable position are formed in the reaction mixture.

Roughly speaking, one can define these compounds as derivatives of C₅H₅FeC₅H₄COCₘHₙ.type, but it is only a pictorial formula and there is no possibility to isolate such compounds from the reaction mixture.

It is thought that the method according to the invention through a use of the specific modifier of combustion results in formation of carbon nanostructures (carbon nanotubes), which enhance a yield of combustion processes in question. The modifier influences a rate of chain reaction of combustion and increases power of ultrared and ultraviolet radiation (luminescence) in lower-temperature range. It reduces a flame size and increases its power of radiation which produces an effect of temperature increase and heat emission by radiation. The temperature increase forces a service staff to supply less fuel, which in turn results in reduction of fuel consumption. At the same time, a consequence of occurring processes is an impact on parts of heating elements and their cleaning. Furthermore, cleaning of a surface in the combustion chamber in a convection part of a boiler from carbon black and soot makes it possible to combust coal of lower calorific value in power and heating equipment and there is no need to change their construction or outfit.

Stable combustion and earlier effect of radiation makes it possible to shut down an additional source of temperature maintenance in the furnace, e.g. a gas flame. As a result of chemical processes taking place the modifier Reduxco reduces to a great extent an amount of emitted gases and their toxicity.

In the method of the invention, composition of the modifier is fed with a metering pump into an air pumping system, temperature of supplied air having no impact. The modifier is metered as an aqueous solution through spraying in the air sucked into the boiler, and then it is pumped to the combustion chamber. In case of cold air it is pumped by means of injector, whereas in case of hot air—a boiler proper is used, from which the modifier evaporates in a hot air stream and is sucked to the combustion system in the boiler.

### EXAMPLE 1

An aqueous solution of the modifier of the following composition was prepared: 20 wt. % of water, 30 wt. % of isopropanol, 30 wt. % of n-butanol, 10 wt. % of carbamide and 10 wt. % of monoacetylferrocene.

### EXAMPLE 2

An aqueous solution of the modifier of the following composition was prepared: 30 wt. % of water, 35 wt. % of isopropanol, 25 wt. % of n-butanol, 5 wt. % of carbamide and 5 wt. % of monoacetylferrocene.

### EXAMPLE 3

An aqueous solution of the modifier of the following composition was prepared: 20 wt. % of water, 50 wt. % of isopropanol, 15 wt. % of carbamid and 15 wt. % of monoacetylferrocene.

In Table below, results of analysis of physicochemical properties of the modifier of the invention are presented.

| Analysis | Value | Unit | Determination method |
|---|---|---|---|
| HEAT OF | 8.2835 | MJ/kg | CALORIMETER |
| COMBUSTION | | | |
| CHLORINE | 0.0297 | % | ION CHROMATOGRAPHY |
| CONTENT | | | |
| SULPHUR | 0.0038 | % | ION CHROMATOGRAPHY |
| CONTENT | | | |
| ASH | | % | PN-EN 15169 |
| FLASH POINT | >55 | ° C. | PN-EN ISO 3680 |
| pH | 2 | | TEST MN 902 04 |
| H₂O₂ TEST | 0 | mg/ | TEST MN QUANTOFIX |
| | | cubic dm | 913 12 |
| NO₃ and NO₂ TEST | 0/0 | mg/ | TEST MN QANTOFIX |
| | | cubic dm | 913 13 |
| CN TEST⁻ | negative | | TEST MN 906 04 |
| | result | | |
| OXIDIZING | negative | | TEST MN 907 54 |
| COMPOUNDS | result | | |

### EXAMPLE 4

The modifier of Example 1 was diluted with water at a ratio of 5, 10 and 30 ml per 1 litre of water. The resulting solution was metered under pressure at a rate of 5 ml/hour into the power boilers, in which coal, natural gas Gz-50 or mazout was used as a fuel. 10, 20 or 30 ml of the diluted modifier per 1000 kg of coal, or 10, 20 and 30 ml of the diluted modifier per 1000 cubic meters of natural gas Gz-50, or 20, 40 and 80 ml of the diluted modifier per 1000 litres of mazout was used (recalculated to fuel mass). Metering was also carried out in a coal-heated boiler equipped with a hot-air recirculating system. The modifier of Example 1 diluted at a ratio of 10 ml of the modifier per 1 litre of water was metered by evaporation in a system including a boiler proper, through which recycled hot air from the boiler was directed.

When using the modifier of Example 1, a power gain of at least 1890 kJ/ton coal was achieved as compared to processes of coal combustion without the modifier.

1. Modifier of combustion of solid, liquid and gaseous fuels, in particular wood, natural gas, coal, mazout and other hydrocarbons, in power boilers, in closed or open chambers, wherein it contains from 10 to 30 wt. % of water, from 20 to 80 wt. % of at least one aliphatic alcohol, from 5 to 15 wt. % of carbamide or its derivatives, and from 5 to 15 wt. % of monoacetylferrocene.

2. Modifier according to claim 1, wherein it contains from 10 to 30 wt. % of water, from 20 to 40 wt. % of isopropanol, from 20 to 40 wt. % of n-butanol, from 5 to 15 wt. % of carbamide and from 5 to 15 wt. % of monoacetylferrocene.

3. Modifier according to claim 1, wherein it contains from 15 to 25 wt. % of water, from 25 to 35 wt. % of isopropanol, from 25 to 35 wt. % of n-butanol, from 8 to 12 wt. % of carbamide and from 8 to 12 wt. % of monoacetylferrocene.

4. Modifier according to claim 1, wherein it contains 20 wt. % of water, 30 wt. % of isopropanol, 30 wt. % of n-butanol, 10 wt. % of carbamide and 10 wt. % of monoacetylferrocene.

5. Method of modifying a process of combustion of solid, liquid and gaseous fuels, in particular wood, natural gas, coal, mazout and other hydrocarbons, in power boilers, in closed or open chambers, wherein the modifier of combustion containing from 10 to 30 wt. % of water, from 20 to 80 wt. % of at least one aliphatic alcohol, from 5 to 15 wt. % of carbamide or its derivatives, and from 5 to 15 wt. % of monoacetylferrocene, is diluted additionally with water at a ratio of 2.5-40 ml of the modifier per 1 litre of water and the resulting diluted composition is metered to an aeration system of combustion chamber, preferably through pumping together with air to the aeration system.

6. Method according to claim 5, wherein the modifier of combustion contains from 10 to 30 wt. %, preferably 20 wt. % of water, from 20 to 40 wt. %, preferably 30 wt. % of isopropanol, from 20 to 40 wt. %, preferably 30 wt. % of n-butanol, from 5 to 15 wt. %, preferably 10 wt. % of carbamide and from 5 to 15 wt. %, preferably 10 wt. % of monoacetylferrocene.

7. Method according to claim 5, wherein in case of aeration of the combustion chamber with cold air, the modifier is metered through spraying, whereas in case of aeration of the combustion chamber with hot air, the boiler proper is used.

8. Method according to claim 5, wherein from 10 to 50 ml of the modifier per 1000 kg of coal or from 5 to 47 ml of the modifier per 1000 cubic metres of natural gas Gz-50 or from 10 to 100 ml of the modifier per 1000 litres of liquid fuels, such as mazout and furnace oil, is metered, whereas the given amounts of modifier are recalculated on the basis of its composition prior to dilution with water.

9. Use of the modifier of combustion defined in claim 1 for increasing a yield of combustion of solid, liquid and gaseous fuels and as a catalyst in power boilers, as well as for after-burning of carbon black, furnace gases and other impurities present in the combustion chamber, for example dusts and coal tar-type substances and for purifying the combustion chamber and canals in power boilers from sludge banks.

10. Use of the modifier of combustion containing water, aliphatic alcohols, carbamide or its derivatives, and monoacetylferrocene, for increasing a yield of combustion of solid, liquid and gaseous fuels and as a catalyst in power boilers, as well as for after-burning carbon black, furnace gases and other impurities present in combustion chamber, for example dusts and coal tar-type substances and for purifying the combustion chamber and canals in power boilers from sludge banks.
